(19) United States
(12) Patent Application Publication
(10) Pub. No.: US 2025/0342283 A1
(43) Pub. Date: Nov. 6, 2025

(54) SAFEGUARDING ELECTRONIC DATA RECORDERS FOR VEHICLES

(71) Applicant: Torc Robotics, Inc., Blacksburg, VA (US)

(72) Inventors: Akshay Pai Raikar, Blacksburg, VA (US); William Davis, Blacksburg, VA (US); Dakota James Hebert, Blacksburg, VA (US); Makarand Phatak, Blacksburg, VA (US); Joseph R. Fox-Rabinovitz, Blacksburg, VA (US)

(21) Appl. No.: 18/652,705

(22) Filed: May 1, 2024

(51) Int. Cl. G06F 21/70

(52) U.S. Cl. CPC G06F 21/70

(57) ABSTRACT

An ejection system is provided that ejects an electronic data recorder (EDR) from a vehicle in response to a triggering event. The ejection system includes a housing that includes the EDR, wherein the EDR is configured to receive and store sensor data generated by the vehicle. The ejection system includes an ejection assembly configured to eject the housing from the vehicle when activated, and at least one processor disposed in the vehicle or the housing. The processor is configured to determine whether the triggering event has occurred and activate the ejection assembly to eject the housing from the vehicle in response to determining that the triggering event has occurred.

### TECHNICAL FIELD

The field of the disclosure relates generally to autonomous and semi-autonomous vehicles, and more particularly, to ensuring recorded event data for vehicles remains viable after unforeseen events, such as a crash.

### BACKGROUND

An electronic data recorder (EDR) is a device installed in a motor vehicle that records technical vehicle and occupant information for a period before, during, and after a crash. The data is preserved generally for the purpose of monitoring and assessing vehicle safety system performance. The recorded data may additionally have legal and insurance implications, as well as be used to improve the safety and quality of future travel.

In modern trucks, EDRs are triggered by electronically sensed problems in the engine (i.e., engine faults), or a sudden change in wheel speed. One or more of these conditions may occur because of an accident. True to their function, EDRs should be able to survive extreme high temperatures and external forces. For example, an industry standard requires that EDRs be capable of withstanding temperatures of up to 1000° C. and forces of up to 500 g. Such standards can be hard to meet in practice. Moreover, even with such manufacturing safeguards, EDR data may be lost in some crash scenarios. The costs associated with data loss can be exacerbated in the case of an autonomous vehicle, where EDR storage may include comprehensive performance logs. Such data regularly includes internal system computations, performance metrics, video, light detection and ranging (LiDAR), and radio detection and ranging (RADAR) data streams used for measuring and improving system, as well as to performance to provide context during system triage. There is, consequently, a need to ensure that the data survives crashes and other unforeseen events.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect an ejection system is provided that ejects an electronic data recorder (EDR) from a vehicle in response to a triggering event. The ejection system includes a housing that includes the EDR, wherein the EDR is configured to receive and store sensor data generated by the vehicle. The ejection system includes an ejection assembly configured to eject the housing from the vehicle when activated, and at least one processor disposed in the vehicle or the housing. The processor is configured to determine whether the triggering event has occurred and activate the ejection assembly to eject the housing from the vehicle in response to determining that the triggering event has occurred.

In another aspect, a method of ejecting an electronic data recorder (EDR) from a vehicle in response to a triggering event is provided. The vehicle includes a housing that includes the EDR and an ejection assembly configured to eject the housing from the vehicle when activated. The method includes receiving and storing, by the EDR, sensor data generated by the vehicle. The method includes determining whether the triggering event has occurred. The method includes activating the ejection assembly to eject the housing from the vehicle in response to determining that the triggering event has occurred.

In yet another aspect, a vehicle is provided that is configured to eject an electronic data recorder (EDR) in response to identifying that the vehicle is about to crash. The vehicle includes a housing that includes the EDR, wherein the EDR is configured to receive and store sensor data generated by the vehicle, at least one communication interface configured to communicatively couple the EDR to the vehicle, and at least one processor. The vehicle includes an ejection assembly configured to eject the housing from the vehicle when activated. The at least one processor is configured to identify whether the vehicle is about to crash, activate the ejection assembly to eject the housing from the vehicle in response to identifying that the vehicle is about to crash, receive, from the vehicle during the crash via the at least one communication interface, updates to the sensor data generated by the vehicle, and provide the updates to the sensor data to the EDR for storage by the EDR.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is an illustration of an autonomous vehicle having an EDR that may be ejected in an exemplary embodiment;

FIG. 2 is a block diagram of a computing device in an exemplary embodiment;

FIG. 3 is a block diagram of an autonomous driving system;

FIG. 4 is a block diagram of one embodiment of an EDR ejection system juxtaposed with an outline of a vehicle in an exemplary embodiment; and

FIG. 5 is a flow chart of one embodiment of a method of ejecting an EDR from a vehicle in response to a triggering event.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

As described above, it is desirable to ensure that data recorded by an EDR survives unforeseen events, such as crashes, fires, vehicle submersion, etc., to ensure a post-event analysis of the data recorded by the EDR remains available. In the embodiments described herein, EDRs are ejected from a vehicle in response to detecting various triggering conditions. Once ejected, the EDRs are removed from the various forces, temperatures, hostile environments, etc., that the vehicle may be subjected to, thereby ensuring that the data recorded by the EDR remains viable for a post-event analysis. In some embodiments, the EDRs may continue to receive and record event data from the vehicle (e.g., as long as the vehicle remains capable of providing such data to the EDRs), thereby ensuring that the post-event analysis is provided with as much event data as possible. Some examples of the various triggering conditions include, but are not limited to, identifying accelerations or temperatures that exceed threshold values, identifying failures of the vehicle systems (e.g., failures in communication networks, power supplies, etc., of the vehicle), identifying that the vehicle is submerged in water, identifying an impending crash of the vehicle, etc.

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, or steering wheel positioning, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA. The semi-autonomous vehicle requires a human driver at all times for operating the semi-autonomous vehicle.

A non-autonomous vehicle: A non-autonomous vehicle is a vehicle that is driven by a human driver. A non-autonomous vehicle is neither an autonomous vehicle nor a semi-autonomous vehicle. A non-autonomous vehicle has an autonomy level of level-0 recognized by NHTSA.

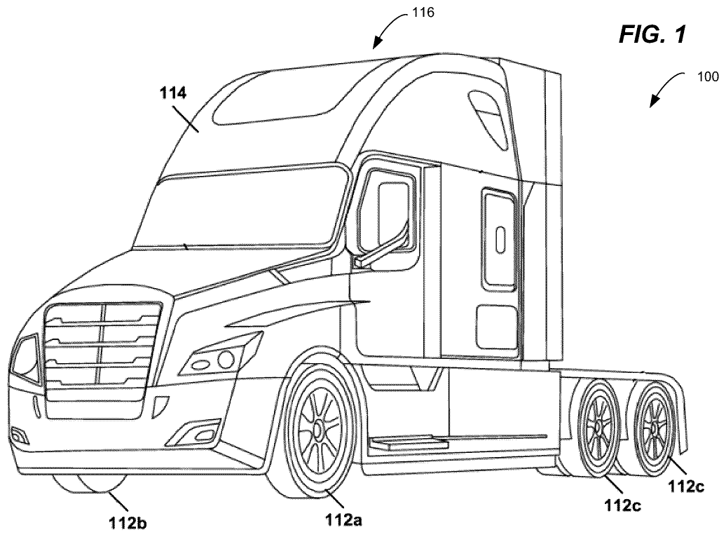

FIG. 1 is an outline of an autonomous vehicle 100 including an EDR that may be ejected in an exemplary embodiment. Autonomous vehicle 100 may include a truck that may further be conventionally connected to a single or tandem trailer to transport the trailers (not shown) to a desired location. Autonomous vehicle 100 includes a cab 114 that can be supported by, and steered in, the required direction by front wheels 112a, 112b, and rear wheels 112c that are partially shown in FIG. 1. Front wheels 112a, 112b are positioned by a steering system that includes a steering wheel and a steering column (not shown in FIG. 1). The steering wheel and the steering column may be located in the interior of cab 114. The steering wheel and the steering column, as well as the entire cabin may be omitted in an autonomous vehicle. An EDR 116 may record technical vehicle information. Generally, EDR 116 may be located near a top of autonomous vehicle 100, in order to provide a clear path for ejecting EDR 116 during various detected triggering events. However, EDR 116 may be located at other positions of autonomous vehicle 100 in different embodiments.

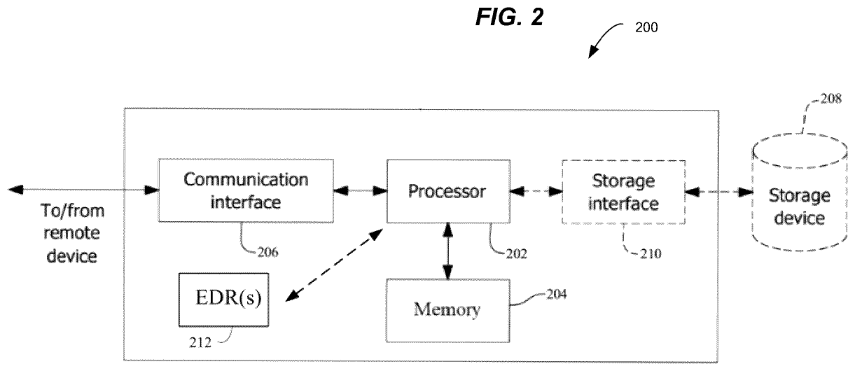

FIG. 2 is a block diagram of a computing device 200 in an exemplary embodiment. Computing device 200 may include one or more processing units or processors 202 (e.g., in a multi-core configuration). Processor 202 may be operatively coupled to a communication interface 206 such that computing device 200 is capable of communicating with another device, such as a remote application server, a user equipment, a mobile device, a smart vehicle, a mission control or a central hub, or another computing device, for example, using wireless communication or data transmission over one or more radio links or digital communication channels using one or more of a Wi-Fi protocol, an RFID protocol, or a Near-Field Communication (NFC) protocol, as one-way communication or two-way communication.

Processor 202 may also be operatively coupled to a storage device 208. Storage device 208 may be any computer-operated hardware suitable for storing or retrieving data, such as, but not limited to, data associated with historic databases. In some embodiments, storage device 208 may be integrated in computing device 200. For example, computing device 200 may include one or more hard disk drives as storage device 208.

In other embodiments, storage device 208 may be external to computing device 200 and may be accessed by a using a storage interface 210. For example, storage device 208 may include a storage area network (SAN), a network attached storage (NAS) system, or multiple storage units such as hard disks or solid-state disks in a redundant array of inexpensive disks (RAID) configuration.

In some embodiments, processor 202 may be operatively coupled to storage device 208 via storage interface 210. Storage interface 210 may be any component capable of providing processor 202 with access to storage device 208. Storage interface 210 may include, for example, an Advanced Technology Attachment (ATA) adapter, a Serial ATA (SATA) adapter, a Small Computer System Interface (SCSI) adapter, a RAID controller, a SAN adapter, a network adapter, or any component providing processor 202 with access to storage device 208.

Processor 202 may execute computer-executable instructions for implementing aspects of the disclosure. In some embodiments, processor 202 may be transformed into a special purpose microprocessor by executing computer-executable instructions or by otherwise being programmed. In some embodiments, and by way of a non-limiting example, memory 204 may include instructions to perform specific operations, as described herein.

In certain implementations, processor 202 may be in communications with one or more EDR(s) 212. In such a configuration, the processor 202 may initiate ejection of EDR(s) 212 as described herein. For instance, processor 202 may sense a crash is imminent and eject EDR(s) 212, accordingly. In other implementations, the EDR(s) 212 are self-contained and have sensing and activation circuitry and processors included within or proximate a housing that surrounds each of EDR(s) 212.

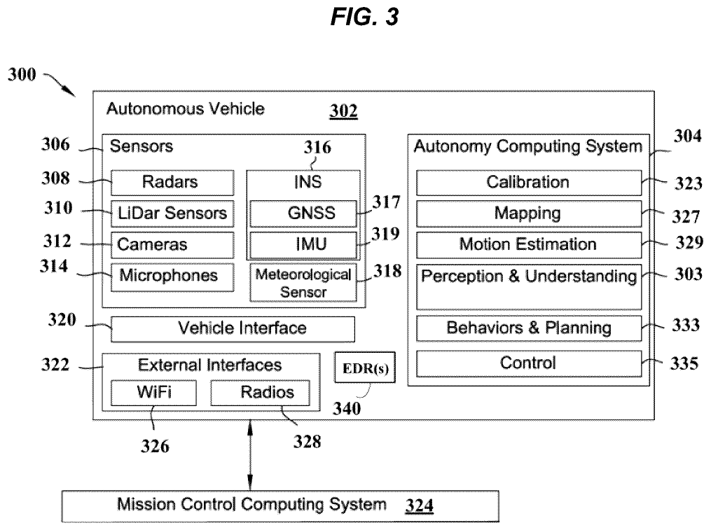

FIG. 3 is a block diagram of an autonomous driving system 300, including an autonomous vehicle 302 communicatively coupled with a mission control computing system 324. Autonomous vehicle 302 may be similar or the same as described with reference to any vehicles of the preceding or subsequent figures.

In some embodiments, autonomous vehicle 302 includes sensors 306. Sensors 306 may include radio detection and ranging (RADAR) sensors 308, light detection and ranging (LiDAR) sensors 310, cameras 312, and acoustic sensors 314. Sensors 306 may further include an inertial navigation system (INS) 316 configured to determine states such as the location, orientation, and velocity of autonomous vehicle 302. INS 316 may include at least one global navigation satellite system (GNSS) receiver 317 configured to provide positioning, navigation, and timing using satellites. INS 316 may also include at least one inertial measurement unit (IMU) 319 configured to measure motion properties such as the angular velocity, linear acceleration, or orientation (e.g., tipping) of autonomous vehicle 302. Sensors 306 may further include meteorological sensors 318. Meteorological sensors 318 may include a temperature sensor, a humidity sensor, an anemometer, pitot tubes, a barometer, a precipitation sensor, or a combination thereof. Meteorological sensors 318 are used to acquire meteorological data, such as the humidity, atmospheric pressure, wind, or precipitation, of the ambient environment of autonomous vehicle 302.

Cameras 312 are configured to capture images of the environment surrounding autonomous vehicle 302 in any aspect or field of view (FOV). The FOV can have any angle or aspect such that images of the areas ahead of, to the side, behind, above, or below autonomous vehicle 302 may be captured. In some embodiments, the FOV may be limited to particular areas around autonomous vehicle 302 (e.g., forward of autonomous vehicle 302, to the sides of autonomous vehicle 302, etc.) or may surround 360 degrees of autonomous vehicle 302. In some embodiments, autonomous vehicle 302 includes multiple cameras 312, and the images from each of the multiple cameras 312 may be stitched or combined to generate a visual representation of the multiple cameras' FOVs, which may be used to, for example, generate a bird's eye view of the environment surrounding autonomous vehicle 302. In some embodiments, the image data generated by cameras 312 may be sent to autonomy computing system 304 or other aspects of autonomous vehicle 302, and this image data may include autonomous vehicle 302 or a generated representation of autonomous vehicle 302. In some embodiments, one or more systems or components of autonomy computing system 304 may overlay labels to the features depicted in the image data, such as on a raster layer or other semantic layer of a high-definition (HD) map.

LiDAR sensors 310 generally include a laser generator and a detector that send and receive a LiDAR signal such that LiDAR point clouds (or “LiDAR images”) of the areas ahead of, to the side, behind, above, or below autonomous vehicle 302 can be captured and represented in the LiDAR point clouds. Radar sensors 308 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 312, radar sensors 308, or LiDAR sensors 310 may be fused or used in combination to determine conditions (e.g., locations of other objects) around autonomous vehicle 302.

GNSS receiver 317 is positioned on autonomous vehicle 302 and may be configured to determine a location of autonomous vehicle 302, which it may embody as GNSS data, as described herein. GNSS receiver 317 may be configured to receive one or more signals from a global navigation satellite system (e.g., Global Positioning System (GPS) constellation) to localize autonomous vehicle 302 via geolocation. In some embodiments, GNSS receiver 317 may provide an input to or be configured to interact with, update, or otherwise utilize one or more digital maps, such as an HD map (e.g., in a raster layer or other semantic map). In some embodiments, GNSS receiver 317 may provide direct velocity measurement via inspection of the Doppler effect on the signal carrier wave. Multiple GNSS receivers 317 may also provide direct measurements of the orientation of autonomous vehicle 302. For example, with two GNSS receivers 317, two attitude angles (e.g., roll and yaw) may be measured or determined. In some embodiments, autonomous vehicle 302 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 302 and its environment.

IMU 319 is a micro-electrical-mechanical (MEMS) device that measures and reports one or more features regarding the motion of autonomous vehicle 302, although other implementations are contemplated, such as mechanical, fiber-optic gyro (FOG), or FOG-on-chip (SiFOG) devices. IMU 319 may measure an acceleration, angular rate, and or an orientation of autonomous vehicle 302 or one or more of its individual components using a combination of accelerometers, gyroscopes, or magnetometers. IMU 319 may detect linear acceleration using one or more accelerometers and rotational rate using one or more gyroscopes and attitude information from one or more magnetometers. In some embodiments, IMU 319 may be communicatively coupled to one or more other systems, for example, GNSS receiver 317 and may provide input to and receive output from GNSS receiver 317 such that autonomy computing system 304 is able to determine the motive characteristics (acceleration, speed/direction, orientation/attitude, etc.) of autonomous vehicle 302.

Autonomous vehicle 302 may further include a vehicle interface 320, which interfaces with an engine control unit (ECU) (not shown) or a MCU (not shown) of autonomous vehicle 302 to control the operation of the autonomous vehicle 302 such as acceleration, braking and steering.

Autonomous vehicle 302 may further include external interfaces 322 configured to communicate with external devices or systems such as another vehicle or mission control computing system 324. External interfaces 322 may include Wi-Fi 326, other radios 328 such as Bluetooth, or other suitable wired or wireless transceivers such as cellular communication devices. Data detected by sensors 306 may be transmitted to mission control computing system 324 via any of the external interfaces 322.

Autonomous vehicle 302 may further include an autonomy computing system 304. Autonomy computing system 304 may control driving of the autonomous vehicle 302 through the vehicle interface 320. Autonomy computing system 304 may operate autonomous vehicle 302 to drive the autonomous vehicle from one location to another.

In some embodiments, autonomy computing system 304 may include modules 323 for performing various functions. Modules 323 may include a calibration module 325, a mapping module 327, a motion estimation module 329, perception and understanding module 303, behaviors and planning module 333, and a control module 335. Modules 323 and submodules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 302.

In some embodiments, based on the data collected from sensors 306, autonomy computing system 304 and, more specifically, perception and understanding module 303 senses the environment surrounding autonomous vehicle 302 by gathering and interpreting sensor data. Perception and understanding module 303 interprets the sensed environment by identifying and classifying objects or groups of objects in the environment. For example, perception and understanding module 303 in combination with sensors 306 (e.g., LiDAR, camera, radar, etc.) of autonomous vehicle 302 may identify one or more objects (e.g., pedestrians, vehicles, debris, etc.) and features of a roadway (e.g., lane lines) around autonomous vehicle 302, and classify the objects in the road distinctly.

In some embodiments, a method of controlling an autonomous vehicle, such as autonomous vehicle 302, includes collecting perception data representing a perceived environment of autonomous vehicle 302 using the perception and understanding module 303, comparing the perception data collected with digital map data, and modifying operation of autonomous vehicle 302 based on an amount of difference between the perception data and the digital map data. Perception data may include sensor data from sensors 306, such as cameras 312, LiDAR sensors 310, RADAR devices 308, or from other components such as motion estimation module 329 and mapping module 327.

Mapping module 327 receives perception data or raw sensor data that can be compared to one or more digital maps stored in mapping module 327 to determine where autonomous vehicle 302 is in the world or where autonomous vehicle 302 is on the digital map(s). In particular, mapping module 327 may receive perception data from perception and understanding module 303 or from the various sensors sensing the environment surrounding autonomous vehicle 302 and may correlate features of the sensed environment with details (e.g., digital representations of the features of the sensed environment) on the one or more digital maps. The digital map may have various levels of detail and can be, for example, a raster map, or a vector map. The digital maps may be stored locally on autonomous vehicle 302 or stored and accessed remotely. In at least one embodiment, autonomous vehicle 302 deploys with sufficient stored information in one or more digital map files to complete a mission without connection to an external network during the mission.

Behaviors and planning module 333 and control module 335 plan and implement one or more behavior-based trajectories to operate autonomous vehicle 302 similarly to a human driver-based operation. Behaviors and planning module 333 and control module 335 use inputs from perception and understanding module 303 or mapping module 327 and motion estimation module 329 to generate trajectories or other planned behaviors. For example, behavior and planning module 333 may generate potential trajectories or actions and select one or more of the trajectories to follow or enact by control module 335 as autonomous vehicle 302 travels along the road. The trajectories may be generated based on proper (i.e., legal, customary, and safe) interaction with other static and dynamic objects in the environment. Behaviors and planning module 333 may generate local objectives (e.g., following rules or restrictions) such as, for example, lane changes, stopping at stop signs, etc. Additionally, behavior and planning module 333 may be communicatively coupled to, include, or otherwise interact with motion planners, which may generate paths or actions to achieve local objectives. Local objectives may include, for example, reaching a goal location while avoiding obstacle collisions.

Based on the data collected from sensors 306, autonomy computing system 304 performs calibration, analysis, and planning, and control the operation and performance of autonomous vehicle 302. For example, autonomy computing system 304 estimates the motion of autonomous vehicle 302, calibrates parameters of the sensors, such as the extrinsic rotations of cameras, LIDAR, RADAR, and IMU, as well as intrinsic parameters, such as lens distortions, in real-time, and provides a map of surroundings of autonomous vehicle 302 or the travel routes of autonomous vehicle 302. The autonomy computing system 304 analyzes the behaviors of autonomous vehicle 302 and generates and adjusts the trajectory plans for autonomous vehicle 302 based on the behaviors computed by behaviors and planning module 333.

In certain implementations, autonomy computing system 304 may be in communications with one or more EDR(s) 340. EDR(s) 340 may operate similarly to EDR 116 and EDR(s) 212 described previously. In such a configuration, autonomy computing system 304 may initiate ejection of EDR(s) 340 in response to detecting various triggering criteria. For instance, autonomy computing system 304 may sense a crash is imminent and eject EDR(s) 340, accordingly. In other implementations, the EDR(s) 340 are self-contained and have sensing and activation circuitry and processors included within or proximate to a housing of each of EDR(s) 340. An autonomous implementation may include a module that communicates with the sensors and the triggering, or such functions may be done in a separate physical module. In the latter case, the triggering hardware may not be in communication with autonomy computing system 304 according to an embodiment. Only the recording portion of EDR(s) 340 may be in communication to do the actual recording.

In some embodiments, mission control computing system 324 may transmit control commands or data to autonomous vehicle 302, navigation commands, and travel trajectories to the autonomous vehicle 302, and may receive telematics data from the autonomous vehicle 302 via external interface 322.

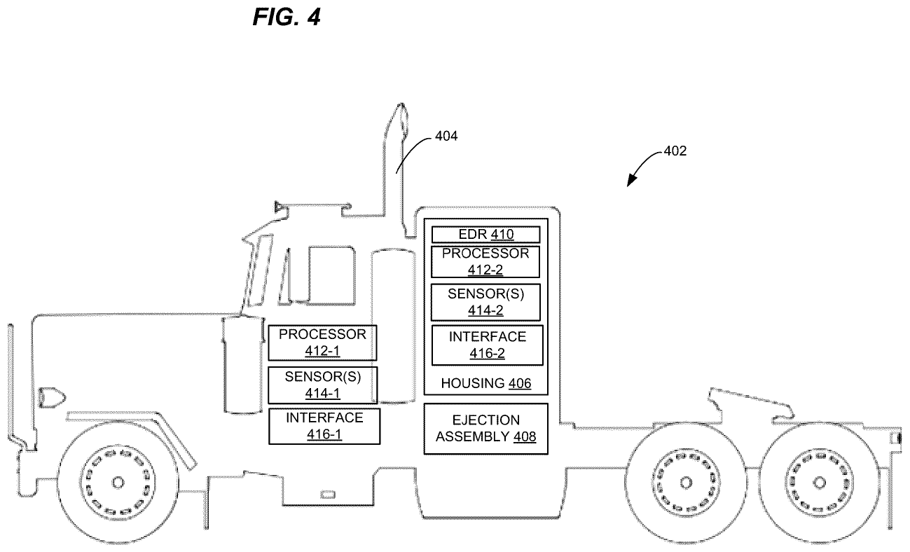

FIG. 4 is a block diagram of an EDR ejection system 402 juxtaposed with an outline of a vehicle 404 in an exemplary embodiment. Vehicle 404 may include the same or similar functionality as previously described with respect to autonomous vehicle 302, such as autonomy computing system 304, sensors 306, vehicle interface 320, and external interfaces 322 (see FIG. 3).

EDR ejection system 402 comprises any component, system, or device that performs the functionality described herein for EDR ejection system 402. EDR ejection system 402 will be described with respect to various discrete elements and their respective functions. These elements may be combined in different embodiments or segmented into different discrete elements in other embodiments.

In the embodiment shown in FIG. 4, EDR ejection system 402 includes a housing 406 and an ejection assembly 408. Housing 406 includes an EDR 410. EDR 410 may operate similarly to EDR 116 and EDR(s) 212, 344 discussed previously. Vehicle 404 or housing 406 may include at least one or more processors 412-1, 412-2, respectively, one or more sensors 414-1, 414-2, respectively, and one or more communication interfaces 416-1, 416-2, respectively.

Processors 412-1, 412-2 may operate similarly to processor 202 previously described. Sensors 414-1, 414-2 may include temperature sensors, accelerometers, water immersion sensors, or may include some of all of sensors 306 previously described with respect to FIG. 3. Communication interfaces 416-1, 416-2 may include wired or wireless interfaces in different embodiments. One example of a wired interface includes Ethernet. Some examples of wireless interfaces include Wi-Fi, cellular networks, Bluetooth, etc. Communication interfaces 416-1, 416-2 may include some or all of the external interfaces 322 previously described with respect to FIG. 3.

Communication interfaces 416-1, 416-2 may be used, for example, to allow vehicle 404 to continue to provide sensor data to EDR 410 after housing 406 is ejected from vehicle 404.

In the embodiments shown in FIG. 4, EDR ejection system 402 operates to eject housing 406, which includes EDR 410, in response to detecting various triggering events, using ejection assembly 408. Ejection assembly 408 may include, for example, pneumatic devices or spring-loaded devices that, when activated, eject housing 406 from vehicle 404. Once ejected, vehicle 404 may continue to provide sensor data to EDR 410 using communication interfaces 416-1, 416-2. In one example, vehicle 404 continues to provide senor data to EDR 410 after housing 406 is ejected from vehicle 404 via a wireless communication interface (e.g., communication interfaces 416-1, 416-2 are wireless interfaces). In another example, vehicle 404 continues to provide sensor data to EDR 410 after housing 406 is ejected from vehicle 404 via wired communication interfaces (e.g., communication interfaces 416-1, 416-2 are wired interfaces). A wired interface may be supported by a tether (not shown) extending between housing 406 and ejection assembly 408 when housing 406 is ejected from vehicle 404.

In some embodiments, ejection assembly 408 operates in conjunction with one or more drones (not shown) in order to eject housing 406 from vehicle 404. For example, ejection assembly 408 may provide an initial force to eject housing 406 from vehicle 404, with one or more drones attached to housing 406 operating to continue an ejection trajectory for housing 406.

Once housing 406 is ejected from vehicle 404, various secondary actions may occur to protect housing 406 from damage from hitting the ground or suspend housing 406 proximate to vehicle 404 or to locate housing 406.

In one embodiment, housing 406 may include an airbag assembly (not shown) deployed in response to one or more actions by processor 412-1 or processor 412-2 upon ejecting housing 406 from vehicle 404. The airbag assembly surrounds housing 406 to provide protection to housing 406 as housing 406 contacts and rolls on the ground.

In another embodiment, housing 406 includes a balloon assembly (not shown) that inflates in response to one or more actions by processor 412-1 or processor 412-2 upon ejecting housing 406 from vehicle 404. The balloon assembly suspends, at least temporarily, housing 406 in the air. In embodiments where EDR ejection system 402 includes a tether, the tether may tether housing 406 within a pre-defined distance from vehicle 404.

In another embodiment, housing 406 includes one or more parachute(s) (not shown) deployed in response to one or more actions by processor 412-1 or processor 412-2 upon ejecting housing 406 from vehicle 404. The parachute(s) slow the decent of housing 406 in response to ejecting housing 406 from vehicle 404.

In some embodiments, one or more of the previous embodiments may be combined. For example, a parachute or a balloon may be combined with an airbag assembly, such that the airbag assembly is activated in response to housing 406 arriving at a pre-defined distance from the ground during a decent. In another example, the parachute or the balloons may be released at a pre-defined distance or at a pre-defined time after housing 406 is ejected, with the airbag assembly deployed in order to cushion housing 406 during the decent of housing 406 to the ground.

Once ejected, housing 406 may be located using one or more beacons (not shown) within housing 406 that broadcast a wireless homing signal when activated in response to housing 406 being ejected. A beacon may be used, for example, if housing 406 is not tethered to ejection assembly 408 after housing 406 is ejected from vehicle 404.

As briefly discussed above, EDR ejection system 402 operates to eject housing 406 (and correspondingly, EDR 410) in response to EDR ejection system 402 determining whether various triggering conditions have occurred.

In one embodiment, one or more of processors 412-1, 412-2 activates ejection assembly 408 to eject housing 406 from vehicle 404 in response to identifying an impending crash of vehicle 404. An impending crash of vehicle 404 may be predicted, for example, by autonomy computing system 304 (see FIG. 3) and relayed to one or more of processors 412-1, 412-2 that activate ejection assembly 408 to eject housing 406, and correspondingly, EDR 410 from vehicle 404.

In another embodiment, one or more of processors 412-1, 412-2 activates ejection assembly 408 to eject housing 406 from vehicle 404 in response to determining a temperature, or an acceleration measured by one or more of sensors 414-1, 414-2 exceeds a threshold value. For example, housing 406 may be ejected in response to a high temperature caused by a fire, a high acceleration caused by a crash, etc.

In another embodiment, one or more of processors 412-1, 412-2 activates ejection assembly 408 to eject housing 406 from vehicle 404 in response to determining that a one or more of sensors 414-1, 414-2 indicate that system(s) of vehicle 404 have failed. For example, housing 406 may be ejected in response to electronic failures at vehicle 404, power supply failures at vehicle 404, or other types of failures at vehicle 404 indicating that vehicle 404 is damaged or partially or fully inoperable.

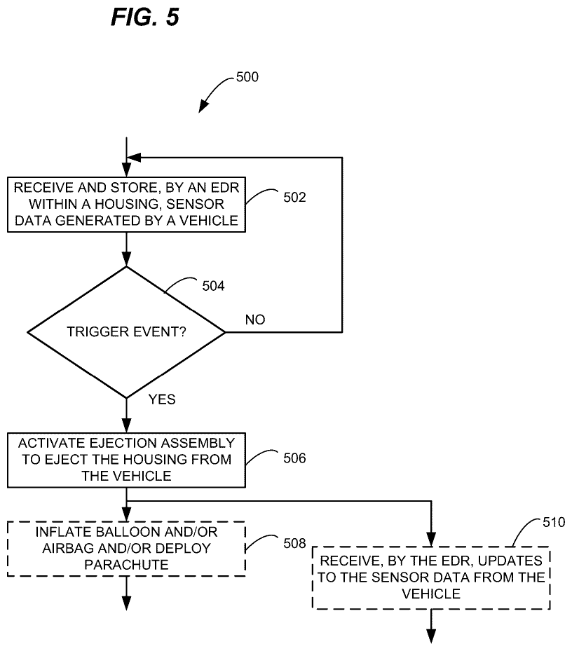

FIG. 5 is a flow chart of a method 500 of ejecting an EDR from a vehicle in response to a triggering event in an exemplary embodiment. Method 500 will be discussed with respect to EDR ejection system 402 and vehicle 404 of FIG. 4, although method 500 may be performed by other systems and other vehicles, not shown.

Method 500 includes receiving and storing 502 sensor data generated by a vehicle. For example, EDR 410 (see FIG. 4) receives and stores sensor data generated by vehicle 404. The sensor data generated by vehicle 404 may include any information associated with vehicle 100, autonomous vehicle 302, and vehicle 404 as previously described.

Method 500 further includes determining 504 whether a triggering event has occurred. For example, processor 412-1 or processor 412-2 determines whether any of the previously described triggering events have occurred, such as identifying a pending crash of vehicle 404, determining if a temperature or acceleration exceeds a threshold value, determining if one or more systems of vehicle 404 have failed, determining that vehicle 404 is submerged or partially submerged in water, etc.

If a triggering event is detected, then method 500 further includes activating 506 an ejection assembly to eject the housing from the vehicle. For example, processor 412-1 or processor 412-2 activates ejection assembly 408 (see FIG. 4) to eject housing 406 from vehicle 404. In response to being activated, ejection assembly 408 ejects housing 406 along with EDR 410 from vehicle 404, thereby removing EDR 410 from a potentially hostile environment around vehicle 404.

In an optional embodiment, method 500 further comprises inflating 508 a balloon assembly or inflating an airbag assembly or deploying a parachute coupled to the housing in response to ejecting the housing from the vehicle. For example, processor 412-1 or processor 412-2 cause a balloon assembly or an airbag assembly to inflate, or processor 412-1 or processor 412-2 cause one or more parachutes to deploy, as previously described.

In another optional embodiment, method 500 further comprises receiving 510, by the EDR, updates to the sensor data from the vehicle after the EDR is ejected from the vehicle. For example, EDR 410 continues to receive sensor data updates from vehicle 404 after housing 406 is ejected from vehicle 404, via communication interfaces 416-1, 416-2.

An example technical effect of the apparatus and method described herein includes one or more of: (i) preventing the loss of EDR data or damage to an EDR during unforeseen events, such as fires, crashes, water entries, etc., for a vehicle; and (ii) ensuring that the EDR continues to record data for a vehicle up to, during, and after a crash or other unforeseen event after the EDR is ejected from the vehicle, using wireless or wired communication interfaces between the vehicle and the EDR.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An ejection system configured to eject an electronic data recorder (EDR) from a vehicle in response to a triggering event, the ejection system comprising:
a housing that includes the EDR, wherein the EDR is configured to receive and store sensor data generated by the vehicle;
an ejection assembly configured to eject the housing from the vehicle when activated; and
at least one processor disposed in the vehicle that is configured to:
determine whether the triggering event has occurred; and
activate the ejection assembly to eject the housing from the vehicle in response to determining that the triggering event has occurred.

2. The ejection system of claim 1, wherein:
the at least one processor is further configured to determine that the triggering event has occurred in response to identifying an impending crash of the vehicle.

3. The ejection system of claim 1, further comprising:
at least one temperature sensor disposed in the vehicle and/or the housing,
wherein the at least one processor is further configured to determine that the triggering event has occurred in response to determining that a temperature measured by the at least one temperature sensor exceeds a threshold value.

4. The ejection system of claim 1, further comprising:
at least one accelerometer disposed in the vehicle and/or the housing,
wherein the at least one processor is further configured to determine that the triggering event has occurred in response to determining that an acceleration measured by the at least one accelerometer exceeds a threshold value.

5. The ejection system of claim 1, wherein:
the at least one processor is further configured to determine that the triggering event has occurred in response to determining that one or more systems of the vehicle have failed.

6. The ejection system of claim 1, further comprising:
at least one water immersion detector disposed in the vehicle and/or the housing,
wherein the at least one processor is further configured to determine that the triggering event has occurred in response to determining, via the at least one water immersion detector, that the vehicle is submerged in water.

7. The ejection system of claim 1, wherein:
the housing further comprises at least one wireless communication interface configured to communicatively couple the EDR to the vehicle, and
the EDR is further configured to:
receive from the vehicle via the at least one wireless communication interface, updates to the sensor data generated by the vehicle in response to the housing being ejected from the vehicle; and
store the updates to the sensor data.

8. The ejection system of claim 1, further comprising:
a tether configured to couple the housing to the vehicle in response to the housing being ejected from the vehicle, wherein the tether includes at least one wired communication interface configured to communicatively couple the EDR to the vehicle, and
wherein the EDR is further configured to:
receive, via the at least one wired communication interface, updates to the sensor data generated by the vehicle in response to the housing being ejected from the vehicle; and
store the updates to the sensor data.

9. The ejection system of claim 8, wherein:
the housing further includes a balloon assembly configured to suspend the housing aloft when inflated, and
the at least one processor is further configured to cause the balloon assembly to inflate in response to the housing being ejected from the vehicle.

10. The ejection system of claim 1, wherein:
the housing further includes a parachute configured to slow a decent of the housing when deployed, and
the at least one processor is further configured to cause the parachute to deploy in response to the housing being ejected from the vehicle.

11. The ejection system of claim 1, wherein:
the housing further includes an airbag assembly configured to surround and protect the housing when inflated, and
the at least one processor is further configured to cause the airbag assembly to inflate in response to the housing being ejected from the vehicle.

12. The ejection system of claim 1, wherein:
the ejection assembly utilizes one or more spring-loaded devices to eject the housing from the vehicle.

13. The ejection system of claim 1, wherein:
the ejection assembly utilizes one or more pneumatic devices to eject the housing from the vehicle.

14. The ejection system of claim 1, wherein:
the housing further includes a beacon configured to broadcast a wireless homing signal when activated, and
the at least one processor is further configured to cause the beacon to activate in response to the housing being ejected from the vehicle.

15. A method of ejecting an electronic data recorder (EDR) from a vehicle in response to a triggering event, wherein the vehicle includes a housing that includes the EDR and an ejection assembly configured to eject the housing from the vehicle when activated, the method comprising:
receiving and storing, by the EDR, sensor data generated by the vehicle;
determining whether the triggering event has occurred; and
activating the ejection assembly to eject the housing from the vehicle in response to determining that the triggering event has occurred.

16. The method of claim 15, wherein determining that the triggering event has occurred further comprises at least one of:
identifying a prediction of an impending crash of the vehicle;
determining that a temperature measured by at least one temperature sensor disposed in the vehicle and/or the housing exceeds a threshold temperature value;
determining that an acceleration measured by at least one accelerometer disposed in the vehicle and/or the housing exceeds a threshold acceleration value;
determining that one or more systems of the vehicle have failed; and
determining that the vehicle is submerged in water.

17. The method of claim 15, further comprising:
receiving, by the EDR, via at least one wireless communication interface of the housing, updates to the sensor data generated by the vehicle in response to the housing being ejected from the vehicle; and
storing, by the EDR, the updates to the sensor data.

18. The method of claim 15, further comprising:
receiving, by the EDR via a at least one wired communication interface of a tether coupling the housing to the vehicle, updates to the sensor data generated by the vehicle in response to the housing being ejected from the vehicle; and
storing, by the EDR, the updates to the sensor data.

19. The method of claim 15, further comprising, in response to the housing being ejected from the vehicle, at least one of:
inflating a balloon assembly of the housing to suspend the housing aloft;
deploying a parachute of the housing to slow a decent of the housing; and
inflating an airbag assembly of the housing to surround and protect the housing.

20. A vehicle configured to eject an electronic data recorder (EDR) in response to identifying that the vehicle is about to crash, the vehicle comprising:
a housing that includes:
the EDR, wherein the EDR is configured to receive and store sensor data generated by the vehicle;
at least one communication interface configured to communicatively couple the EDR to the vehicle; and
at least one processor; and
an ejection assembly configured to eject the housing from the vehicle when activated,
wherein the at least one processor is configured to:
identify whether the vehicle is about to crash;
activate the ejection assembly to eject the housing from the vehicle in response to identifying that the vehicle is about to crash;
receive, from the vehicle during the crash via the at least one communication interface, updates to the sensor data generated by the vehicle; and
provide the updates to the sensor data to the EDR for storage by the EDR.
